(19) United States
(12) Patent Application Publication
(10) Pub. No.: US 2003/0038830 A1
(43) Pub. Date: Feb. 27, 2003

(54) Method and system for simultaneous display of a video sequence in multiple time-offset windows

(76) Inventors: Heather N. Bean, Fort Collins, CO (US); Mark N. Robins, Greeley, CO (US); Matt Flach, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/934,879

(22) Filed: Aug. 22, 2001

(51) Int. Cl. G06F 3/00

(52) U.S. Cl. 345/719

(57) ABSTRACT

A video sequence is shown simultaneously in multiple time-offset windows, each of which has an associated audio channel. The audio channel associated with at least one of the windows may be selected and played. Applications involving both delayed and time-advanced time offsets among the windows are supported.

### FIELD OF THE INVENTION

The present invention relates generally to video and more specifically to a method and system for displaying simultaneously a video sequence in multiple time-offset windows.

### BACKGROUND OF THE INVENTION

In recent years, video applications have become increasingly popular on personal computers. Advances in processor speed, the decreasing cost of random access memory (RAM), and the advent of Digital Versatile Discs (DVDs) using the popular Motion Picture Experts Group (MPEG) compression standard have made possible a wide variety of video-related hardware and software. Digital TVs configured to receive and process digital cable TV or satellite TV signals are also becoming popular with consumers.

Recorded video, whether digital or analog, has the distinct advantage that the viewer may queue and watch a video sequence beginning at any desired point within the sequence. Video systems typically include controls such as “play,” “stop,” “pause,” “search forward” or “fast forward,” and “search backward” or “rewind.”Some video systems also provide the ability to watch multiple video sequences simultaneously. For example, a computer user may watch several different MPEG video sequences at the same time on a monitor. However, whether the video system supports only one or multiple simultaneous video sequences, each video sequence appears within its own single-frame-sized viewing area on the display. If a viewer desires to replay an earlier portion of a video sequence or to skip ahead to obtain an overview of its content, the viewer must do so within the single viewing area. In some situations, especially those involving long video sequences such as movies on DVD, searching for a specific segment or obtaining an overview of the content can require considerable time. A viewer's temporal perception of a video sequence is fundamentally limited because only one portion of the video sequence may be viewed at any given time. It is thus apparent that there is a need in the art for an improved method and system for displaying video sequences.

### SUMMARY OF THE INVENTION

A method is provided for displaying simultaneously a video sequence in multiple time-offset windows. A system is also provided to implement the method.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is block diagram of a computer in accordance with an exemplary embodiment of the invention.

FIG. 1B is a block diagram of a video system comprising a portion of the exemplary embodiment of the invention shown in FIG. 1A.

FIG. 2A is a diagram of a first method for organizing a buffer memory in support of multiple video windows.

FIG. 2B is a diagram of a second method for organizing a buffer memory in support of multiple video windows.

FIG. 3A is an illustration of an exemplary embodiment of the invention prior to the selection of a particular video window.

FIG. 3B is an illustration of an exemplary embodiment of the invention after the selection of a particular video window.

FIG. 4A is an illustration of an exemplary embodiment of the invention showing the time relationships among a set of video windows prior to the selection of a particular video window.

FIG. 4B is an illustration of an exemplary embodiment of the invention showing the time relationships among a set of video windows after a particular video window has been selected.

FIG. 4C is an illustration of an exemplary embodiment of the invention showing the time relationships among a set of video windows after the original video window has been re-selected.

FIG. 5 is flowchart showing the operation of the computer shown in FIG. 1 in accordance with an exemplary embodiment of the invention.

FIG. 6A is an illustration of another exemplary embodiment of the invention prior to the selection of particular a video window.

FIG. 6B is an illustration of another exemplary embodiment of the invention after the selection of a particular video window.

FIG. 7 is a flowchart of the operation of the computer shown in FIG. 1 in accordance with another exemplary embodiment of the invention.

FIG. 8 is an illustration of yet another exemplary embodiment of the invention.

FIG. 9 is a flowchart of the operation of the computer shown in FIG. 1 in accordance with yet another embodiment of the invention.

FIG. 10 is an illustration of a further exemplary embodiment of the invention.

FIG. 11 is a flowchart of the operation of the computer shown in FIG. 1 in accordance with a further exemplary embodiment of the invention.

FIG. 12 is an illustration of a user interface for specifying the number, configuration, and time relationships of video windows in accordance with an exemplary embodiment of the invention.

FIG. 13A is an illustration of a first user interface for adjusting the time differential between video windows while a video sequence is being displayed in accordance with an exemplary embodiment of the invention.

FIG. 13B is an illustration of a second user interface for adjusting the time differential between video windows while a video sequence is being displayed in accordance with an exemplary embodiment of the invention.

### DETAILED DESCRIPTION OF THE INVENTION

The invention solves the problem of a viewer being able to see only one portion of a video sequence at a time by displaying a single video sequence simultaneously in multiple time-offset video windows. Using the invention, a viewer can quickly see a single video sequence at different points in time, either delayed or time advanced. Throughout this detailed description, a video window denotes a portion of a display device devoted to displaying a single realization of a video sequence. The term, as used here, is distinct from the term “window” commonly used in connection with graphical user interfaces and computer operating systems. In the context of the present invention, the multiple video windows may all reside within a single fixed or floating computer window, in different computer windows, or outside any computer window (e.g., directly on the background or “desktop”).

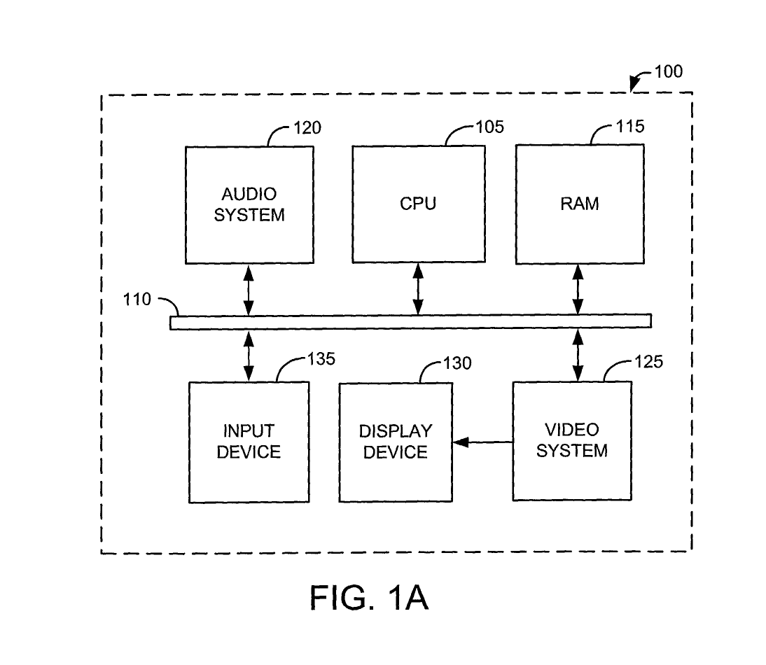

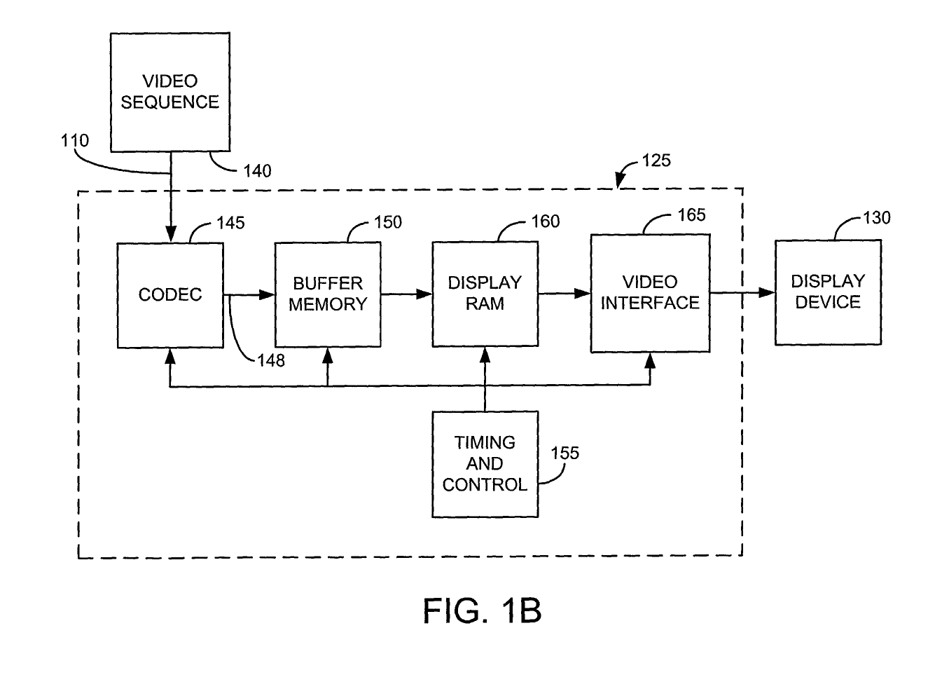

FIG. 1A is a block diagram of a computer 100 in accordance with an exemplary embodiment of the invention. Central processing unit (CPU) 105 communicates via data bus 110 with random access memory (RAM) 115, audio system 120, and video system 125, which in turn outputs video and control signals to display device 130. Input device 135 is also connected to CPU 105 via data bus 110. Audio system 120 typically comprises a sound card, audio input and output jacks, and speakers. Display device 130 is typically a high-resolution color monitor. Input device 135 is typically a mouse, track ball, keyboard, or similar input device for interacting with a graphical user interface. Video system 125 will be explained in further detail.

FIG. 1B is a block diagram of an exemplary implementation of video system 125 shown in FIG. 1A. A video sequence 140 in digital format is fed via data bus 110 to video system 125. If video sequence 140 is in, for example, MPEG format, optional codec 145 converts video sequence 140 to uncompressed digital video data 148. Digital video data 148 is output to buffer memory 150. Under the direction of timing and control circuitry 155, digital video data 148 is transferred at the desired video frame rate from buffer memory 150 to display RAM 160. Display RAM 160 is organized such that each address contained therein maps to a unique pixel location on display device 130. Video interface circuit 165 converts digital video data 148 stored in display RAM 160 to a format compatible with display device 130. Typically, this involves converting digital video data to analog format and inserting timing signals such as vertical and horizontal synchronization pulses. Timing and control circuitry 155 may be implemented advantageously using a dedicated video processor.

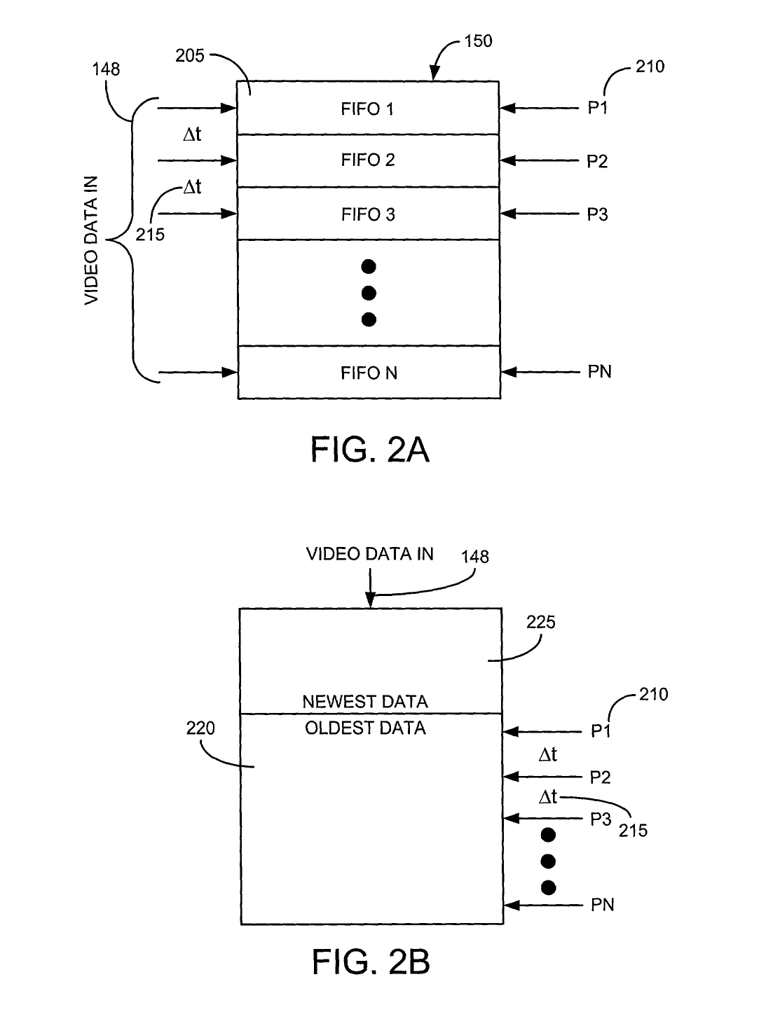

In some situations, buffer memory 150 is large enough to contain the entire video sequence 140. In that case, displaying video sequence 140 in multiple time-offset video windows comprises transferring portions of digital video data 148 from buffer memory 150 to display RAM 160 in accordance with the required video frame rate and the desired delay or time advance among the video windows. As those skilled in the art will recognize, this may be accomplished by a set of movable address pointers, one for each video window. In other situations, buffer memory 150 may hold only a portion of the video sequence at a time. In that case, buffer memory 150 may be organized in at least two different ways. FIG. 2A shows a first exemplary method of organizing buffer memory 150 to support multiple video windows. Buffer memory 150 is divided into N first-in, first-out (FIFO) buffers 205, one for each of N video windows. Digital video data 148 needed for display at any particular time in any given video window may be read, with the appropriate time differential Δt 215, into the corresponding FIFO 205. Time differential Δt, may, in general, be a delay or a time advance. Address pointers 210 may be used to access digital video data 148 within each FIFO. FIG. 2B shows a second exemplary method of organizing buffer memory 150 to support multiple video windows. In this case buffer memory 150 comprises a single FIFO divided into two sections. First section 220 contains the oldest digital video data 148 read into the FIFO. Second section 225 contains the newest digital video data 148 loaded into the FIFO. The writing of digital video data 148 into buffer memory 150 is circular. That is, when the highest numbered address (or lowest numbered, depending on the implementation) is reached, the writing of data wraps around to the opposite end of buffer memory 150 and proceeds. First section 220 contains enough contiguous digital video data 148 to include the greatest delay or time advance. Address pointers 210 may be used to access digital video data 148 at the desired time differential Δt 215 to support each video window. Whether buffer memory 150 is large enough to contain the entire video sequence 140 or not, it may be advantageous in some embodiments to assign a separate operating system process or “thread” to each video window, as those skilled in the art will recognize.

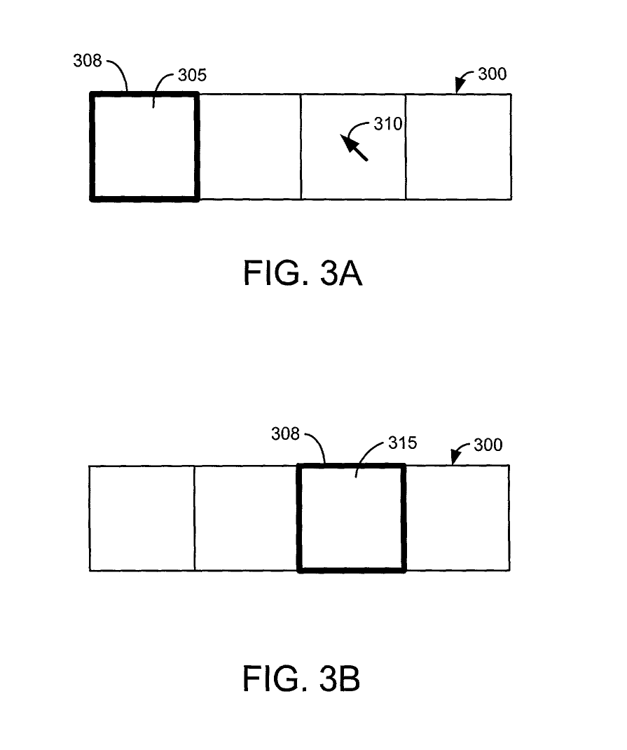

FIG. 3A is an illustration of an exemplary embodiment of the invention in which four time-offset video windows 300 are displayed in a horizontal row. In this embodiment, an audio channel is associated with each video window. Each associated audio channel is synchronized with the realization of video sequence 140 shown within each video window. Four video windows have been included in the diagram of FIG. 3A for the sake of simplicity. More or as few as two video windows may be employed instead. In general, video windows 300 may be arranged in a wide variety of topologies such a single row (as in FIG. 3A), single column (vertical orientation), a grid (two-dimensional array of video windows), or any desired irregular or asymmetric pattern. Also, there is no requirement that video windows 300 be packed closely together as shown in FIG. 3A. In some embodiments, video windows 300 may be separated on display device 130. In FIG. 3A, video window 305 is the currently selected video window, meaning that the audio channel associated with video window 305 is played through audio system 120. The heavy border 308 surrounding video window 305 is used to indicate that this particular video window is currently selected for audio output. Many other possible methods of indicating selection may be employed, such as icons or other annotation, change of size relative to the other video windows, or movement to a specific area of display device 130. Cursor 310 associated with input device 135 may be used to select a different of the four video windows, thereby causing the associated audio channel to be played through audio system 120. FIG. 3B shows the embodiment of FIG. 3A after cursor 310 has been used to select video window 315. Selection may be accomplished by, for example, hovering over video window 315 with cursor 310 or by hovering over video window 315 with cursor 310 and simultaneously depressing a button or otherwise activating a switch on input device 135. For example, hovering with cursor 310 and clicking a mouse button is one suitable implementation. Once video window 315 has been selected, the audio channel associated with video window 315 is played through audio system 120, and border 308 is moved to video window 315.

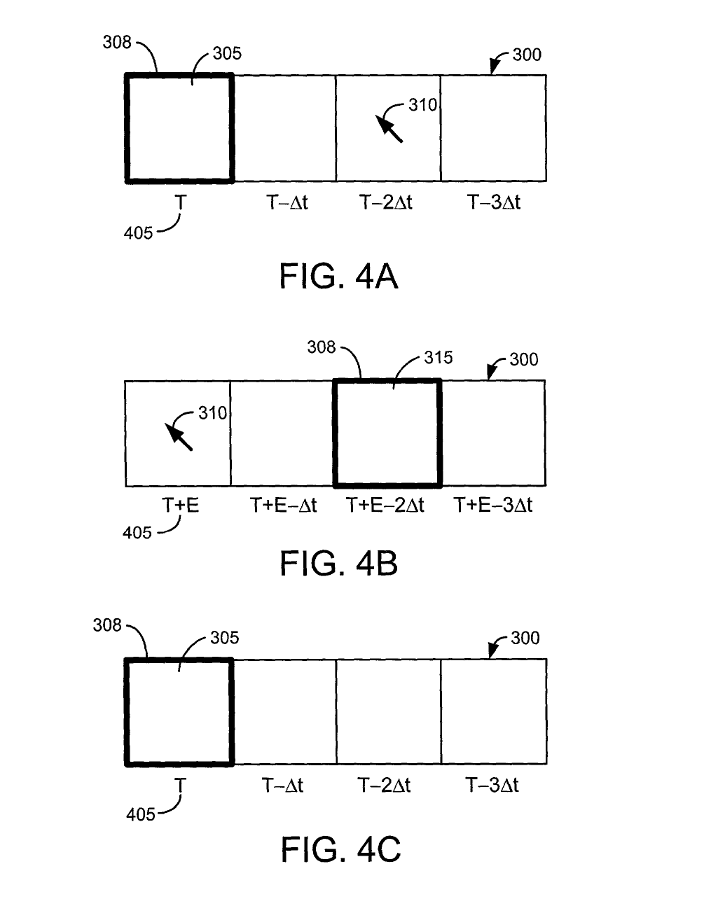

FIG. 4A shows an example of the time relationships among a set of video windows 300 in an exemplary embodiment of the invention. In FIG. 4A, each video window is delayed by time differential Δt 215 with respect to the video window to the immediate left, as time indices 405 indicate. Therefore, each video window 300 has an associated time offset relative to an arbitrary time reference. For convenience in this detailed description, video window 305 has been chosen as the arbitrary time reference in FIG. 4A (and in FIGS. 4B and 4C). Also, whether to have time progress in a left-to-right, right-to-left, up-to-down, or down-to-up fashion is a design choice that depends on the particular application of the invention. Although it is convenient, there is no requirement that every time offset be an integer multiple of a single time differential Δt 215 with respect to an arbitrary time reference. In some embodiments, the relative time offset of each video window may be specified independently of that associated with any other video window. FIG. 4A shows the case of a progressive time delay from left to right among video windows 300. Time delays from left to right are favored in this embodiment because it is optimized for reviewing previously viewed segments of video sequence 140. In variations of this embodiments of the invention, the time offsets from left to right may be time advances instead of delays, an example of which will be given later in this detailed description. FIG. 4B shows the result of a selection operation at video window 315, as explained in connection with FIG. 3B. Time indices 405 have now advanced by elapsed time E, video sequence 140 continues to be displayed in each video window at the indicated time index 405, and the audio channel associated with selected video window 315 is played through audio system 120. In a typical usage scenario, a viewer, while watching video sequence 140 in video window 305, desires to view again a portion of video sequence 140 that was displayed a few seconds ago in video window 305. The viewer may, for example, select video window 315 to re-watch the desired segment beginning 2Δt ago. However, when the viewer returns to video window 305, E seconds have elapsed, and the viewer has missed part of video sequence 140. One method to solve this problem is to store in memory the time index T (405) associated with video window 305 upon the selection of video window 315. If the viewer next selects video window 305 again, as depicted in FIG. 4C, the time index 405 of each video window is reset to its state prior to the selection of video window 315 in FIG. 4B. In this way, the viewer may resume watching video sequence 140 in video window 305 without loss of continuity.

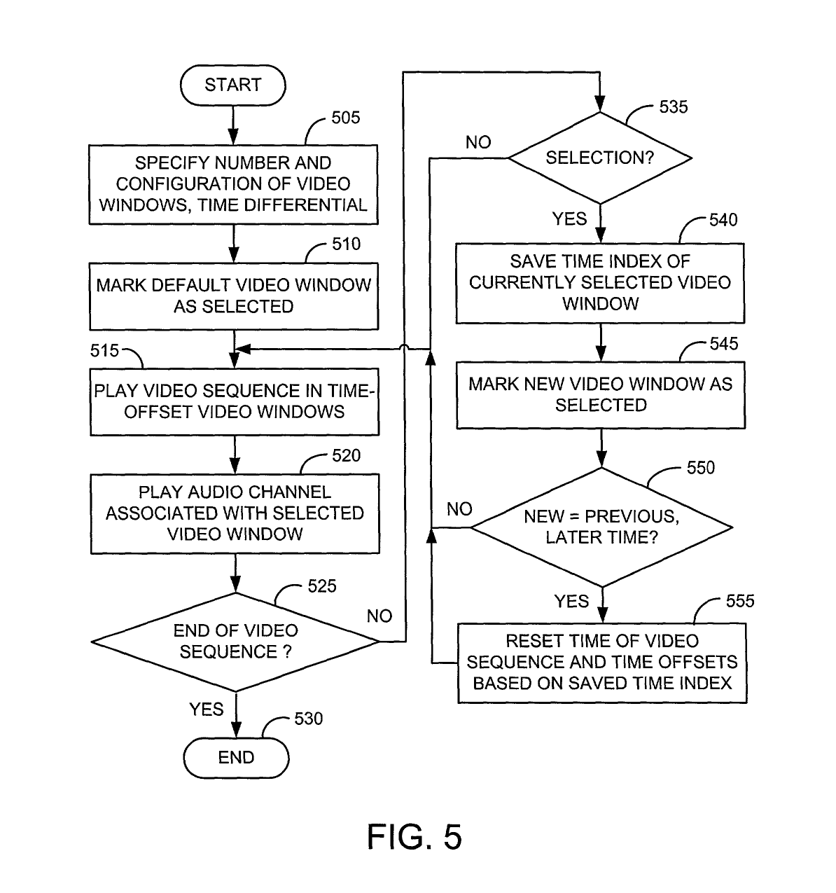

FIG. 5 is a flowchart of the operation of computer 100 in accordance with the exemplary embodiment of the invention illustrated in FIGS. 3A, 3B, and 4A-4C. At 505, a viewer may optionally specify the number and spatial configuration of video windows 300. Also, a time differential Δt may be specified at 505. As mentioned previously, in this particular embodiment, the time differential Δt 215 is assumed to represent a delay rather than a time advance as one moves from left to right among video windows 300. One of the video windows is marked by default as the currently selected video window at 510. Typically, the default selected video window is the earliest or latest video window in time, depending on the application. At 515, the video windows are configured and initialized on display device 130. The audio channel associated with the currently selected video window is played through audio system 120 at 520. At 525, a test is performed to determine whether video sequence 140 has been shown in its entirety in all video windows. If so, the process terminates at 530. Otherwise, control proceeds to 535. If a request to select a different video window is received at 535, the time index 405 associated with the currently selected video window is saved at 540. At 545, the new video window chosen at 535 is marked as selected. If at 550 it is determined that the new video window selected at 535 was the previously selected video window and that the previously selected video window has a later (greater) time index 405 than the currently selected video window, control proceeds to 555. Otherwise, control returns to 515. At 555, the time indices 405 of all video windows 300 are reset as explained in connection with FIG. 4C.

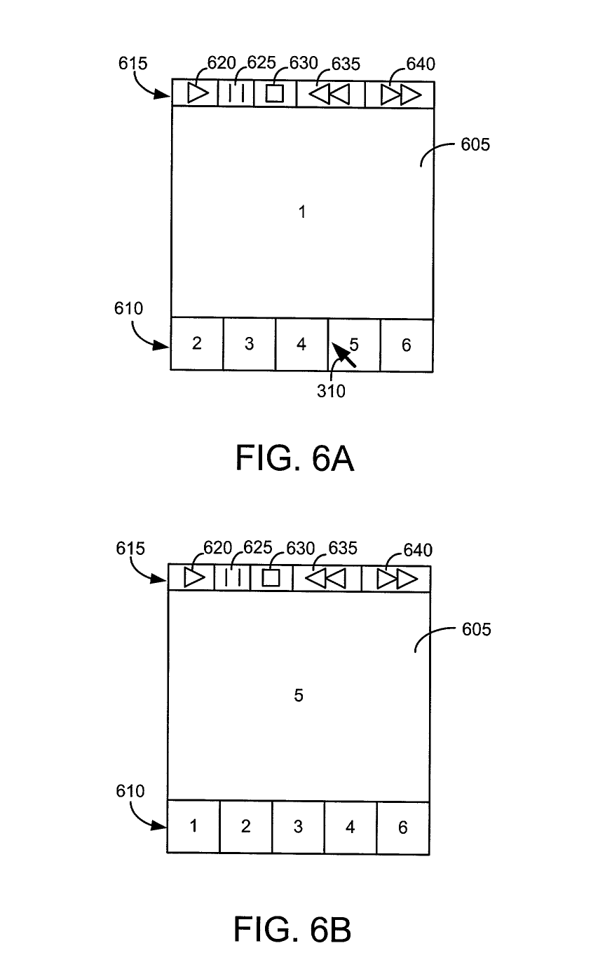

FIGS. 6A and 6B illustrate another exemplary embodiment of the invention incorporating some features different from those already described. In FIG. 6A, video windows 300 are divided into larger primary video window 605 and smaller secondary video windows 610. Primary window 605 may, in this embodiment, be the video window for which the corresponding audio channel is output to audio system 120. Each video window, whether primary or secondary, has been numbered in FIG. 6A to indicate the relative temporal order among the video windows. In this embodiment, the video window labeled “1” may be either the earliest or the latest in time. Therefore, this particular embodiment supports either delays or time advances with respect to primary window 605. This embodiment also includes control elements 615 for controlling the playback of video sequence 140 in primary video window 605. Control elements 615 may include “play” 620, “pause” 625, “stop” 630, “search backward” 635, and “search forward” 640. Additional control elements for adjusting contrast, brightness, color balance, or video window size or for applying special effects may also be included in some embodiments. Those skilled in the art will recognize that a single toggling control element may be used for both “play” and “pause” functions. In that case, the icon labeling the control element is the opposite of the mode currently active. In still other embodiments of the invention, control elements 615 may be replicated within each individual video window for controlling the display of video sequence 140 in that particular video window. In FIG. 6A, cursor 310 is shown hovering over the video window labeled “5.” Upon completion of a selection operation as described in connection with FIG. 3B, the configuration of FIG. 6B results. In FIG. 6B, the video window labeled “5” has been moved to primary video window 605, the video window labeled “1” has been moved to a secondary position among video windows 610, the audio channel associated with the video window labeled “1” has been muted, and the audio channel associated with the video window labeled “5” has been selected for output to audio system 120. Note that the video window labeled “1” has been reduced in size to match the size of the other secondary video windows 610.

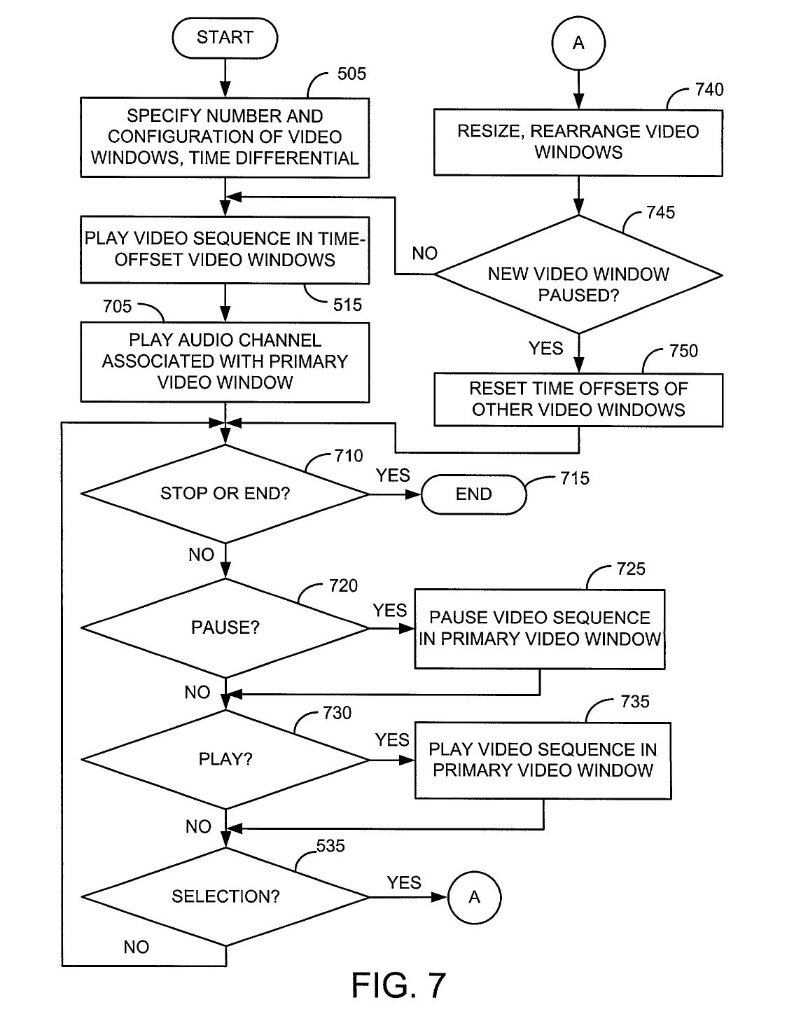

FIG. 7 is a flowchart of the operation of computer 100 in accordance with the exemplary embodiment of the invention illustrated in FIGS. 6A and 6B. Control proceeds initially in a manner similar to that in FIG. 5, except that, at 705, primary video window 605 is selected for audio output and is marked as selected by its larger size instead of by border 308. At 710, a “stop” command from control element 630 may terminate the displaying of video sequence 140 at 715. Otherwise, control proceeds to 720, where a “pause” command received from control element 625 may cause the video sequence 140 being displayed within primary video window 605 to be paused at its current time index 405 at 725. In this particular embodiment, video sequence 140 may remain paused within a particular video window, even if that video window is subsequently moved to a secondary position (610) due to the selection of a different video window. Control then proceeds to 730, where a “play” command may resume the playing of video sequence 140 at 735 after a “pause” command at 720. At 535, a different video window, one of the secondary video windows 610, may be selected to become the new primary video window 605. If a new selection is made at 535, the video windows are resized and rearranged accordingly at 740. Otherwise, control returns to 710. If, at 745, the new video window selected at 535 had been paused prior to becoming the new primary video window 605, the time offsets of all other video windows are reset relative to the time index of the new primary video window at 750 in a manner analogous to the embodiment described in connection with FIG. 5. This approach maintains the continuity of video sequence 140 for a viewer shifting attention from one video window to another and back again. Many variations of the embodiment just described are possible. For example, secondary video windows 610 may be increased in number to completely surround primary video window 605.

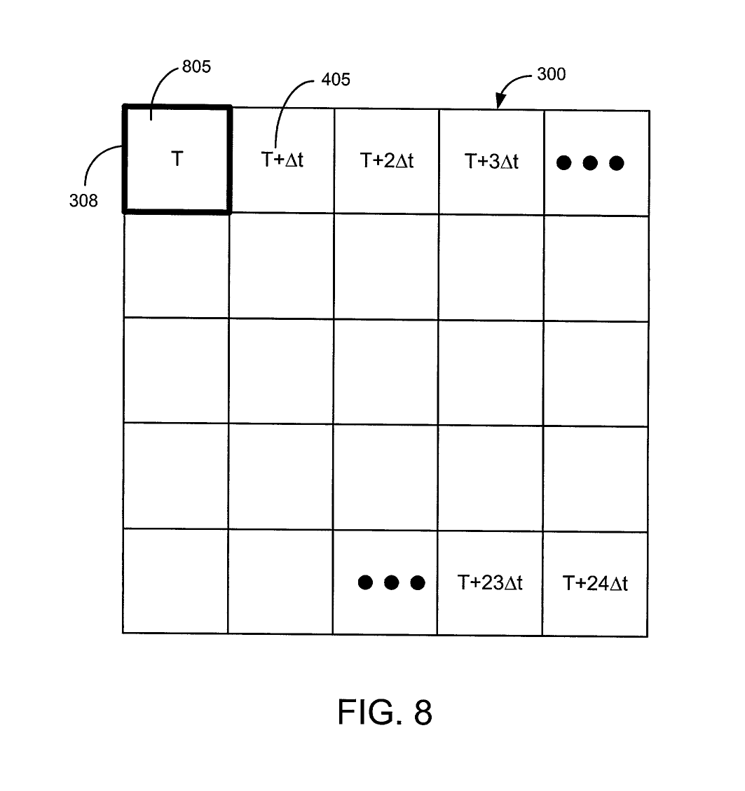

FIG. 8 is an illustration of yet another exemplary embodiment of the invention. In this embodiment, a two-dimensional grid is employed to provide a large number of small video windows 300. For convenience in this detailed description, video window 805 has been designated as an arbitrary time reference in FIG. 8, with respect to which all time offsets are reckoned. Window 805 displays video sequence 140 from the beginning of video sequence 140, and all other video windows are time advanced with respect to video window 805 by an integer multiple of time differential Δt 215. This particular embodiment is configured to provide an overview of substantially all of video sequence 140. For example, a two-hour movie on DVD may be shown simultaneously in 60 small video windows with a two-minute time differential Δt between adjacent video windows. A viewer may quickly identify a section of interest within video sequence 140 by glancing at the time-offset video windows 300. This embodiment may form the basis of a powerful user interface for a video editing application, for example. In FIG. 8, video window 805 is selected for audio output and is marked with border 308.

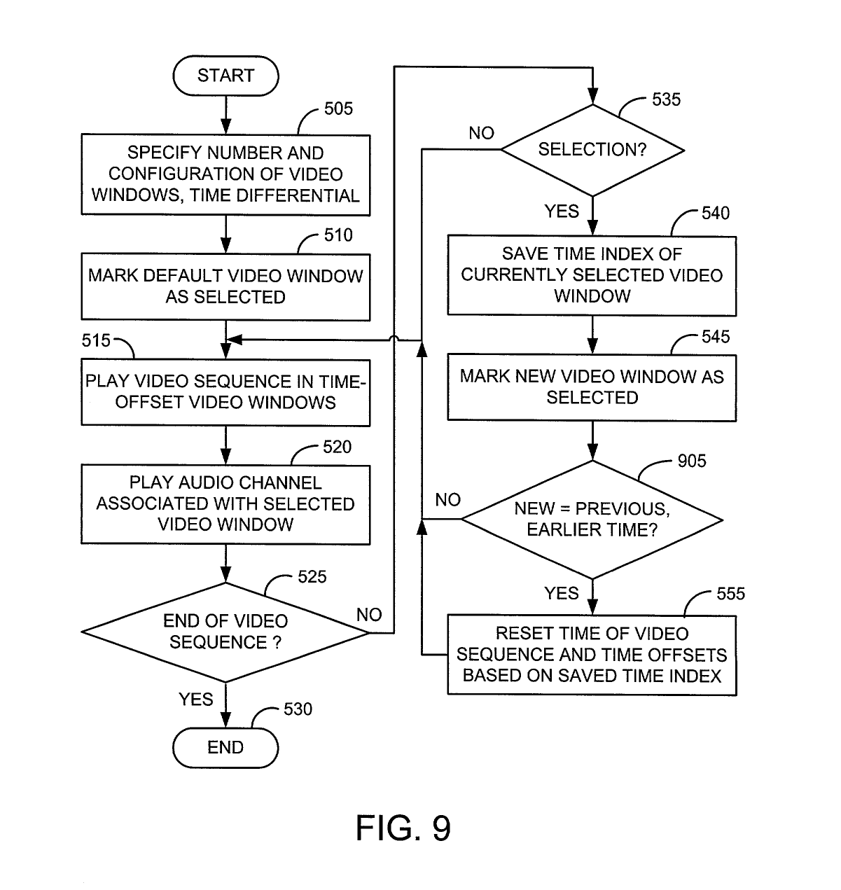

FIG. 9 is a flowchart of the operation of computer 100 in accordance with the exemplary embodiment of the invention illustrated in FIG. 8. This figure is identical to FIG. 5, except that step 550 is modified at 905. In the embodiment of FIG. 9, reselecting the previously selected video window at 535 resets the time offsets at 555 if the previously selected video window has an earlier (smaller) time index 405 than the currently selected video window. This difference results from video windows 300 being time advanced with respect to video window 805 instead of being delayed. This provision may be included to support a viewer shifting attention to a later portion of video sequence 140 and then returning to the original, earlier video window without loss of continuity. Of course, the embodiment shown in FIGS. 8 and 9 may be modified to comprise a grid containing delayed video windows with respect to video window 805 instead of time-advanced video windows.

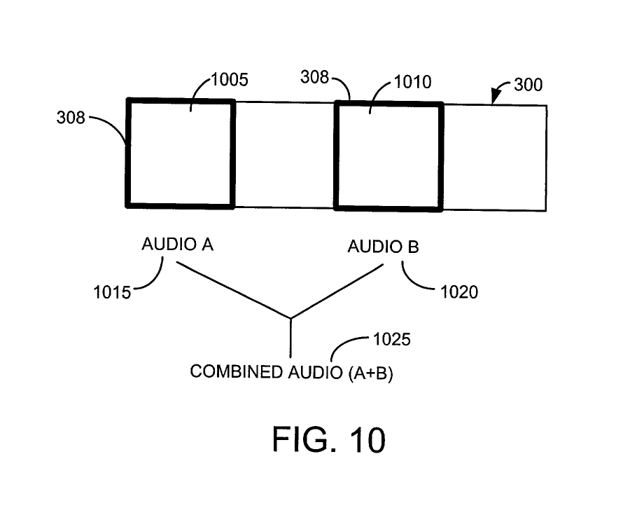

FIG. 10 illustrates a further exemplary embodiment of the invention. In this embodiment, multiple video windows may be selected for simultaneous output to audio system 120. In FIG. 10, both video window 1005 and 1010 are selected for output of Audio A 1015 and Audio B 1020. Audio A 1015 and Audio B 1020 are mixed to form combined audio (A+B) 1025. Enabling time-delayed replicas of the audio from video sequence 140 to be played simultaneously may be useful in, for example, musical or special effects applications. Although FIG. 10 shows two selected video windows, more or even all of the video windows may be selected for audio output.

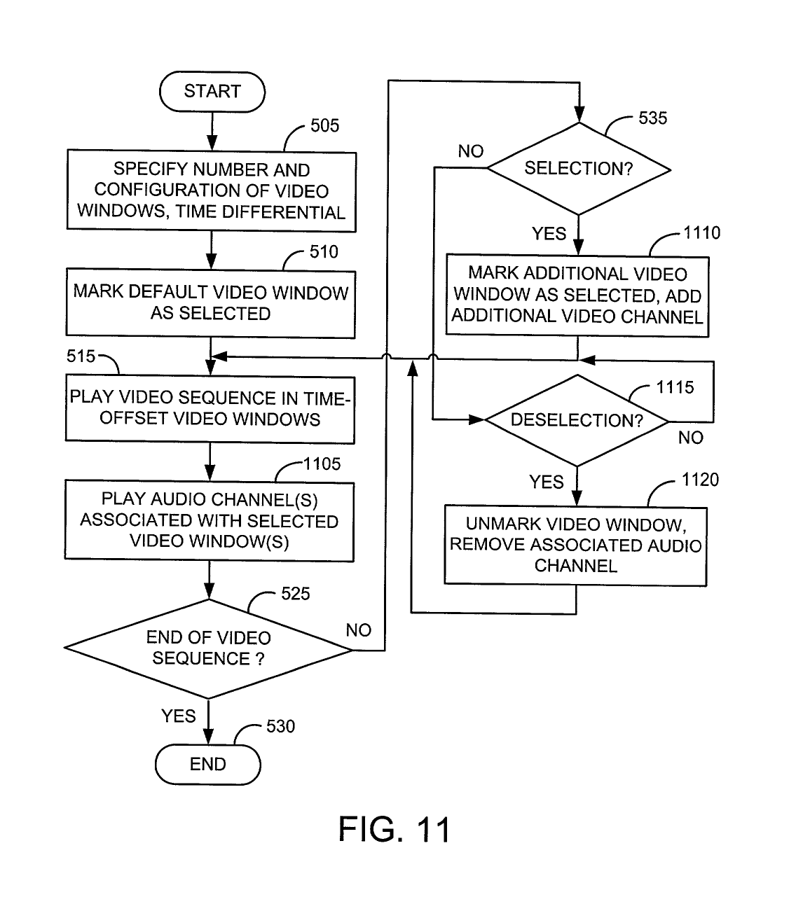

FIG. 11 is a flowchart of the operation of computer 100 in accordance with the further exemplary embodiment of the invention illustrated in FIG. 10. Control proceeds as in FIG. 5 until step 1105, in which the audio channels associated with all selected video windows are played. If a request to select an additional video window is received at 535, the additional video window is marked with border 308 and the associated audio channel is added to the audio mix played through audio system 120 at 1110. If a request to deselect a video window is received at 1115, the applicable video window is unmarked (border 308 removed), and the associated audio channel is removed from the audio mix played through audio system 120 at 1120. Deselecting an already-selected video window may, for example, be accomplished by performing a selection operation at 535 on the already-selected video window.

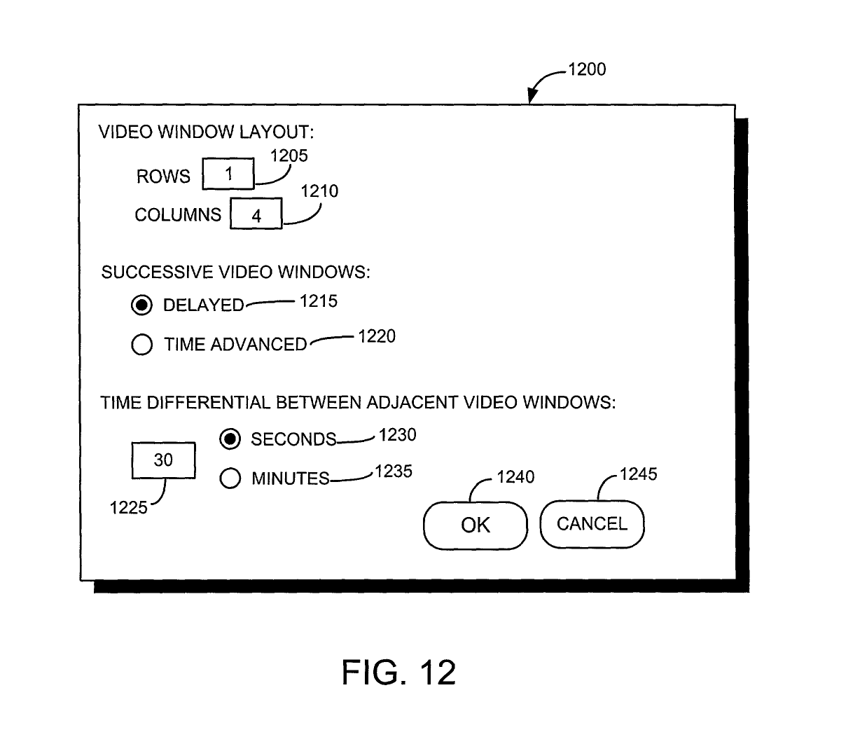

FIG. 12 illustrates a user interface in accordance with an exemplary embodiment of the invention. The exemplary user interface shown in FIG. 12 corresponds to a grid-style layout for video windows 300. Dialog box 1200 contains row dimension field 1205, column dimension field 1210, and time-differential radio buttons for delayed (1215) or time-advanced (1220) operation with respect to an arbitrary time reference such as, for example, the left-most, right-most, bottom-most, top-most, or center video window 300. Dialog box 1200 also contains field 1225 for entering a number of seconds or minutes for time differential Δt 215. Radio buttons 1230 and 1235 select the units for the numerical value entered into field 1225. Virtual button 1240 finalizes the selections made within and dismisses dialog box 1200. Virtual button 1245 cancels the selections made within and dismisses dialog box 1200. Many variations are possible in a user interface such as that shown in FIG. 12. For example, instead of the video windows being specified in terms of a fixed grid, the viewer may instead specify a number of separate, movable video windows that may be arranged on display device 130 in whatever manner the viewer desires.

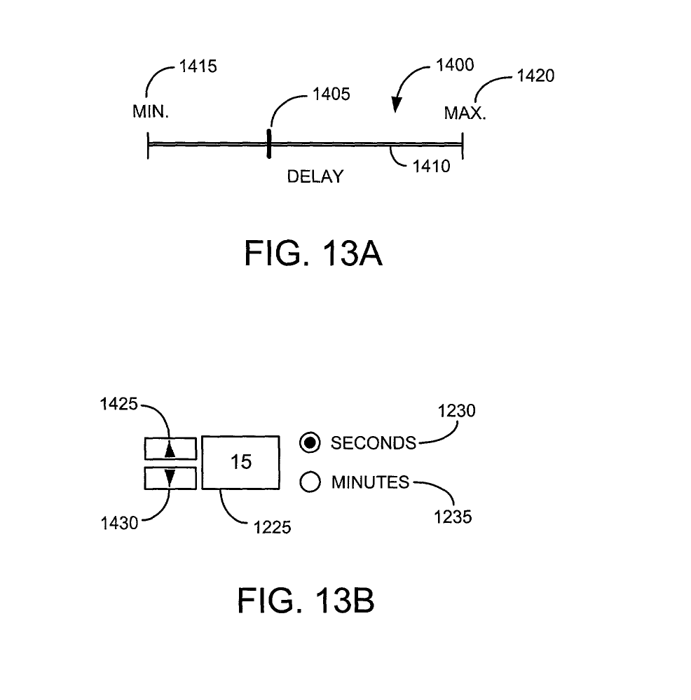

FIGS. 13A and 13B illustrate two different exemplary user interfaces that may be used to adjust time differential Δt 215 while video sequence 140 is being displayed. FIG. 13A shows a simple sliding control 1400. Sliding control element 1405 may be adjusted along track 1410, using input device 135, between minimum delay or time advance 1415 and maximum delay or time advance 1420. The minimum and maximum delay or time advance may be viewer specified, or these parameters may be computed based on the number of video windows and the length of video sequence 140. FIG. 13B shows an alternative method for adjusting time differential Δt 215. In FIG. 13B, control elements 1425 and 1430 are used to increase or decrease, respectively, the numerical quantity in field 1225. As in FIG. 12, radio buttons 1230 and 1235 may be used to select the units associated with the numerical value in field 1225. Being able to adjust time differential Δt 215 while video sequence 140 is being displayed provides considerable power and flexibility to the viewer. Using a user interface such as that shown in FIG. 13A or 13B, the viewer may decrease or increase the temporal granularity of video windows 300 to locate segments of interest rapidly.

Although the invention has been described within the environment of computer 100, the invention may also be embodied in, for example, a television set with sufficient data acquisition (sampling), memory, and processing resources. The invention may be particularly useful in such an environment for the playback of DVDs or videotapes. A digital television with sufficient memory and processing resources is also an environment in which the invention may be embodied.

The foregoing description of the present invention has been presented for the purposes of illustration and description. It is not intended to be exhaustive or to limit the invention to the precise forms disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for displaying a video sequence, comprising:
(a) displaying simultaneously the video sequence in each of at least two video windows, the video sequence being displayed with at least one predetermined time offset between at least two of the video windows, each video window having an associated audio channel;
(b) selecting a first video window; and
(c) playing the audio channel associated with the first video window.

2. The method of claim 1, further comprising:
selecting a second video window; and
playing the audio channel associated with the second video window.

3. The method of claim 2, further comprising:
storing a time index associated with the first video window and playing the audio channel associated with a second video window, when the second video window is selected; and
resuming display of the video sequence in the first video window beginning at the stored time index, resuming play of the audio channel associated with the first video window beginning at the stored time index, and resetting the at least one predetermined time offset relative to the stored time index, when the first video window is re-selected after the second video window has been selected.

4. The method of claim 2, further comprising:
pausing the video sequence in the first video window and its associated audio channel at a particular time index and playing the audio channel associated with a second video window, when the second video window is selected; and
resuming display of the video sequence in the first video window, resuming play of the audio channel associated with the first video window, and resetting the at least one predetermined time offset relative to the particular time index, when a signal to re-select the first video window is received after the second video window has been selected.

5. The method of claim 2, further comprising:
pausing the video sequence in the first video window and its associated audio channel at a particular time index, when a first control element is activated; and
resuming display of the video sequence in the first video window, resuming play of the audio channel associated with the first video window, and resetting the at least one predetermined time offset relative to the particular time index, when a second control element is activated.

6. The method of claim 5, wherein the first control element and the second control element are the same.

7. The method of claim 1, wherein the number of video windows and their spatial configuration on a display device are specified by a user prior to step (a).

8. The method of claim 1, wherein the at least one predetermined time offset is specified by a user prior to step (a).

9. The method of claim 1, further comprising:
adjusting at least one of the at least one predetermined time offsets while the video sequence is being displayed.

10. The method of claim 1, wherein each of the at least one predetermined time offsets is an integer multiple of a time differential.

11. The method of claim 10, further comprising:
adjusting the time differential while the video sequence is being displayed.

12. The method of claim 1, wherein selecting the first video window comprises positioning a cursor over the first video window.

13. The method of claim 1, wherein selecting the first video window comprises activating a pointing device.

14. The method of claim 1, wherein the first video window is larger than the other video windows and further comprising:
reducing the size of the first video window and making a second video window larger than the other video windows, when the second video window is selected.

15. The method of claim 1, further comprising:
moving at least a second video window to a different location relative to the other video windows, when the second video window is selected.

16. The method of claim 1, further comprising:
marking the first video window to differentiate it from the other video windows.

17. The method of claim 16, wherein marking the first video window to differentiate it from the other video windows comprises surrounding the first video window with a border.

18. The method of claim 1, wherein the number of video windows and the at least one predetermined time offset are chosen such that an overview of substantially all of the video sequence is provided in the at least two video windows.

19. The method of claim 1, wherein step (b) comprises selecting at least two video windows simultaneously and step (c) comprises playing simultaneously the audio channel associated with each of the at least two selected video windows.

20. A method for displaying a video sequence, comprising:
(a) specifying at least two video windows to be displayed on a display device;
(b) specifying a spatial configuration for the at least two video windows;
(c) specifying a time differential;
(d) displaying the video sequence in each of the at least two video windows, the video sequence being displayed with at least one predetermined time offset between at least two of the video windows, the at least one predetermined time offset being an integer multiple of the time differential;
(e) marking a first video window as a currently selected video window;
(f) playing a first audio channel associated with the first video window; and
(g) marking a second video window as the currently selected video window and playing a second audio channel associated with the second video window, when a signal to select the second video window is received.

21. The method of claim 20, wherein marking a video window as the currently selected video window comprises surrounding the video window with a border.

22. The method of claim 20, further comprising:
adjusting the time differential while the video sequence is being displayed.

23. The method of claim 20, wherein the signal to select the second video window comprises a cursor being positioned over the second video window.

24. The method of claim 20, wherein the signal to select the second video window comprises the activation of a pointing device.

25. The method of claim 20, further comprising:
storing a time index from the first video window, when the signal to select the second video window is received; and
resuming display of the video sequence in the first video window beginning at the stored time index, resuming play of the first audio channel beginning at the stored time index, and resetting the at least one predetermined time offset relative to the stored time index, when a signal to re-select the first video window is received after the second video window has been selected.

26. The method of claim 20, further comprising:
pausing the video sequence in the first video window at a particular time index, when the signal to select the second video window is received; and
resuming display of the video sequence in the first video window, resuming play of the first audio channel, and resetting the at least one predetermined time offset relative to the particular time index, when a signal to re-select the first video window is received after the second video window has been selected.

27. The method of claim 20, further comprising:
pausing the video sequence in the first video window at a particular time index prior to step (g), when a first control element is activated; and
resuming display of the video sequence in the first video window, resuming play of the first audio channel, and resetting the at least one predetermined time offset relative to the particular time index, when a second control element is activated.

28. The method of claim 27, wherein the first control element and the second control element are the same.

29. The method of claim 20, wherein the first video window is larger than the other video windows during steps (a) through (f) and further comprising:
reducing the size of the first video window and making the second video window larger than the other video windows, when the signal to select the second video window is received.

30. The method of claim 20, further comprising:
moving at least the second video window to a different location relative to the other video windows, when the signal to select the second video window is received.

31. The method of claim 20, wherein the number of video windows and the at least one predetermined time offset are chosen such that an overview of substantially all of the video sequence is provided in the at least two video windows.

32. A system for displaying a video sequence, comprising:
a display device to display the video sequence in each of at least two video windows, the video sequence being displayed with at least one predetermined time offset between at least two of the video windows, each video window having an associated audio channel;
a first memory to store the video sequence in a digitized form, the digitized form comprising digital video data;
a second memory organized such that each address in the second memory corresponds to a unique pixel location on the display device;
a video interface circuit connected between the second memory and the display device to convert digital video data to a format compatible with the display device;
a video processor configured to control the transfer of digital video data from the first memory to the second memory such that the at least one predetermined time offset between the at least two video windows is maintained as the video sequence is displayed;
a user interface configured to select at least one of the video windows; and
an audio sub-system configured to play the audio channel associated with each of the at least one selected video windows.

33. The system for displaying a video sequence of claim 32, further comprising:
a codec to convert the digital video sequence from a compressed to an uncompressed format.

34. The system for displaying a video sequence of claim 32, wherein the first memory is organized as a plurality of FIFO buffers, each FIFO buffer receiving at least one portion of the video sequence corresponding to a unique one of the at least two video windows.

35. The system for displaying a video sequence of claim 32, wherein the first memory is organized as a single FIFO buffer having a first section to store an oldest portion of the video sequence and a second section to store a newest portion of the video sequence, the first section being large enough to span all of the at least one predetermined time offsets associated with the at least two video windows.

36. The system for displaying a video sequence of claim 32, further comprising:
at least one set of virtual control elements on the display, each set of virtual control elements controlling the display of the video sequence within a corresponding video window.

37. The system for displaying a video sequence of claim 36, wherein each set of virtual control elements comprises “play,” “pause,” “stop,” “search forward,” and “search backward.”

38. A system for displaying a video sequence, comprising:
display means for displaying the video sequence in each of at least two video windows, the video sequence being displayed with at least one predetermined time offset between at least two of the video windows, each video window having an associated audio channel;
first memory means for storing the video sequence in a digitized form, the digitized form comprising digital video data;
second memory means for storing digital video data organized such that each address in the second memory means corresponds to a unique pixel location corresponding to the display means;
means for converting digital video data stored in the second memory means to a format compatible with the display means;
means for controlling the transfer of digital video data from the first memory means to the second memory means such that the at least one predetermined time offset between the at least two video windows is maintained as the video sequence is displayed;
means for selecting at least one of the video windows; and
means for playing the audio channel associated with each of the at least one selected video windows.

39. The system for displaying a video sequence of claim 38, further comprising:
means for converting the digital video sequence from a compressed to an uncompressed format.

40. The system for displaying a video sequence of claim 38, wherein the first memory means is organized as a plurality of FIFO buffers, each FIFO buffer receiving at least one portion of the video sequence corresponding to a unique one of the at least two video windows.

41. The system for displaying a video sequence of claim 38, wherein the first memory means is organized as a single FIFO buffer having a first section to store an oldest portion of the video sequence and a second section to store a newest portion of the video sequence, the first section being large enough to span all of the at least one predetermined time offsets associated with the at least two video windows.
